(19) United States
(12) Patent Application Publication
(10) Pub. No.: US 2004/0172269 A1
(43) Pub. Date: Sep. 2, 2004

(54) Mailing list campaign approval system

(76) Inventors: Michael D. Bella, New York, NY (US); Aristotle Spyropoulous, Pearl River, NY (US); Stevan R. Roberts, Port Washington, NY (US)

Correspondence Address: JENKENS & GILCHRIST, P.C., Suite 3200, 1445 Ross Avenue, Dallas, TX, 75202-2799, US

(21) Appl. No.: 10/719,464

(22) Filed: Nov. 21, 2003

Related U.S. Application Data
(60) Provisional application No. 60/428,605, filed on Nov. 22, 2002.

(51) Int. Cl. G06F 17/60

(52) U.S. Cl. 705/1; 705/404

(57) ABSTRACT

A apparatus and method for obtaining approval of the mailing list campaign wherein a proposed mailing list campaign sample is forwarded to a list owner via a computer network such as the Internet. A determination is made if the list owner replies to the provided proposed mailing list campaign sample, and the mailing list campaign is then implemented in accordance with this determination.

### RELATED APPLICATION(S)

This application claims priority from and incorporates herein by reference the entire disclosure of U.S. Provisional Application Serial No. 60/428,605 filed Nov. 22, 2002.

### TECHNICAL FIELD

The present invention relates to approval of mailing campaigns, and more particularly, to a system and method for providing an expedited approval process for a mailing campaign via network.

### BACKGROUND OF THE INVENTION

The mailing list industry has developed into a significant business since its inception many decades ago. The mailing list industry generally includes three major participants, namely, mailing list owners, mailing list managers or brokers, and mailing list purchasers or users. Mailing list owners are typically companies that are able to produce mailing lists from customers that purchase goods and/or services from the company. For example, a newspaper may generate a mailing list from subscribers of the newspaper. To capitalize on the mailing list asset, the mailing list owner may allow mailing purchases, which are typically other companies or organizations, to purchase the use of the mailing list. However, the mailing list owner is generally concerned about the proper and appropriate use of their mailing list. If the mailing list were to be misused by a purchaser of the mailing list, negative sentiments may be directed back to the mailing list owner. For example, if a reputable financial newspaper were to allow a mailing list purchaser to mail a brochure regarding a financial seminar to members on the mailing list, the financial newspaper would likely endorse or approve such a mailing. However, if the mailing list purchaser were to mail a brochure containing sexually explicit content, the financial newspaper would be unlikely to endorse such a mailing.

Traditionally, the mailing list owner has allowed the mailing list manager to broker the mailing list to mailing list purchasers. Prior to 1986, when the facsimile or “fax” machine became widely available, the mailing list manager would sell a mailing list of a mailing list owner and receive a sample of a mailing piece (e.g., flier, brochure, etc.) and mail the mail sample to the mailing list owner. The mailing list owner would, in turn, call via a telephone the mailing list manager with an approval or disapproval of use of the mailing list for that mail sample. Upon the mailing list manager receiving an approval, the mailing list manager would, in turn, notify the mailing list purchaser and the mailing list pieces would be sent to members on the mailing list. The process of the mailing list manager of mailing list purchaser mailing the mail sample to the mailing list owner for approval typically took several days before an approval could be considered, a very inefficient way of doing business.

In 1986, the fax machine became widely available so that mail samples could be faxed to the mailing list owner. This faxing process has improved productivity from days to hours depending on the number of mailing list owners and mail samples. However, while the productivity has improved, the mailing list industry continues to utilize paper as its primary means of communication. Facsimile machines also have various problems, including telephone lines being busy, fax machines becoming jammed, scans being poor in resolution, etc. Additionally, the use of fax is problematic for large mailings. For example, if a magazine licenses out or sells its mailing list to a company, several fax communications are likely necessary for the magazine to approve the sample mail piece. These communications provide for configuration management difficulties in that paper records for approval and copies of the mail sample are to be maintained.

Another historical event occurred approximately 15 to 20 years ago, where the mailing list industry became sophisticated and built thousands of mailing lists. These mailing lists may be comprised of many different mailing list owners so that a purchaser of a single mailing list would need to be authorized or approved for mailing by each of the mailing list owners. This necessitates sending purchase orders and approvals to hundreds and thousands of list owners each time the mailing list is built or rebuilt, thereby requiring repeated operations costing hundreds of hours to fax mail samples to list owners. The sending of purchase order approvals to list owners is cumbersome, time consuming, and costly.

### SUMMARY OF THE INVENTION

The present invention overcomes the foregoing and other problems with an apparatus and method for obtaining approval of the mailing list campaign wherein a proposed mailing list campaign sample is forwarded to a list owner over a computer network such as the Internet using a server. A determination is made if the list owner has replied to the proposed mailing list campaign sample and in accordance with this determination, the mailing list campaign is implemented.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a diagram illustrating the environment of operation for the mailing list campaign approval system of the present invention;

FIG. 2 is a block diagram illustrating the various functional components of the mailing list accounting campaign approval system;

FIG. 3 is a functional block diagram of the mailing list campaign approval system;

FIG. 4 is an illustration of an approval screen from which a list owner can approve or disapprove of a mailing list campaign;

FIG. 5 is an illustration of an email sent to a list owner to obtain approval of a mailing campaign;

FIG. 6 illustrates the confirmation email sent to a list owner responsive to their approval/disapproval of a mailing list campaign;

FIG. 7 illustrates an email received by a campaign administrator after a campaign has expired; and

FIG. 8 is a flow diagram describing the operation of the mailing list campaign approval system.

### DETAILED DESCRIPTION

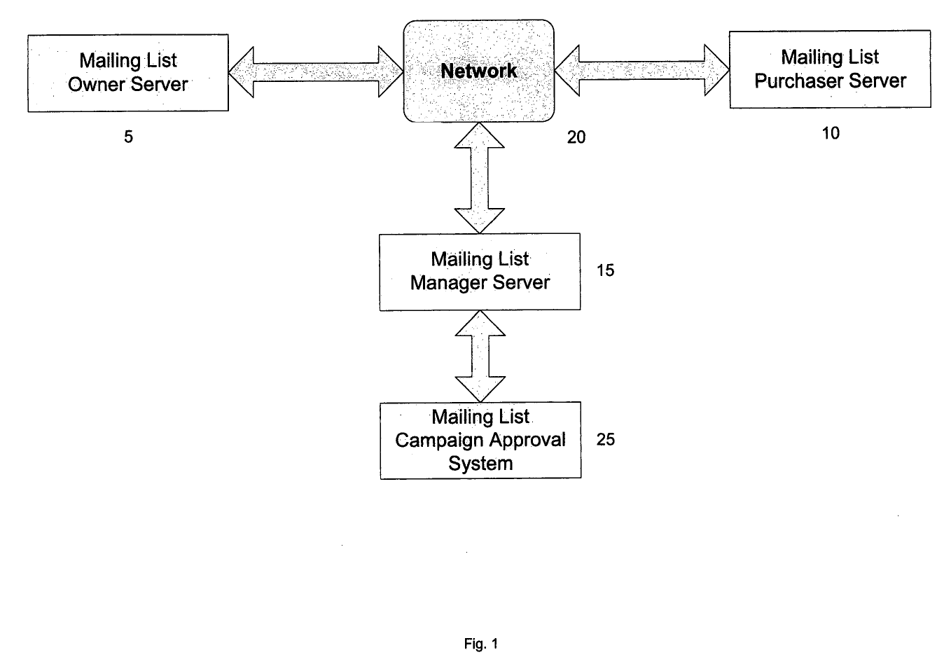

Referring now to the drawings, and more particularly to FIG. 1, there is illustrated the operating environment of the mailing list campaign approval system of the present invention. The system includes each of a mailing list owner server 5 associated with the mailing list owner, a mailing list purchaser server 10 associated with a mailing list purchaser and a mailing list manager server 15 associated with a mailing list manager interconnected via some type of network 20. In an exemplary embodiment, the network 20 would comprise the Internet. However, other types of private or publicly accessible networks would work equally well with the system described. The mailing list manager server 15 has associated therewith a mailing list campaign approval system 25. The mailing list campaign approval system 25 provides for an automatic and/or semi-automatic process for distributing mailing samples to mailing list owners via the network 20 to enable substantially simultaneous distribution of mailing samples. The mailing list campaign approval system 25 provides a centralized or distributed system enabling a mailing list manager to gain approval of mailing owners for mailing samples in a time frame and manner that greatly reduces the cost and efforts for the mailing list owners, mailing list managers, and mailing list purchasers. The mailing list campaign approval system 25 provides a graphical user interface and graphical representation computer files such as PDF or TIFF formatted files or other graphical formats capable of being distributed across the network 20 between the mailing list manager server 15, mailing list owner server 5 and mailing list purchaser server 10. The mailing list owners and mailing list purchasers may log on to a web site 30 maintained on the mailing list manager server 15 by the mailing list campaign approval system 25 via their own servers 5, 10 in order to upload mailing samples and approve or disapprove of the samples.

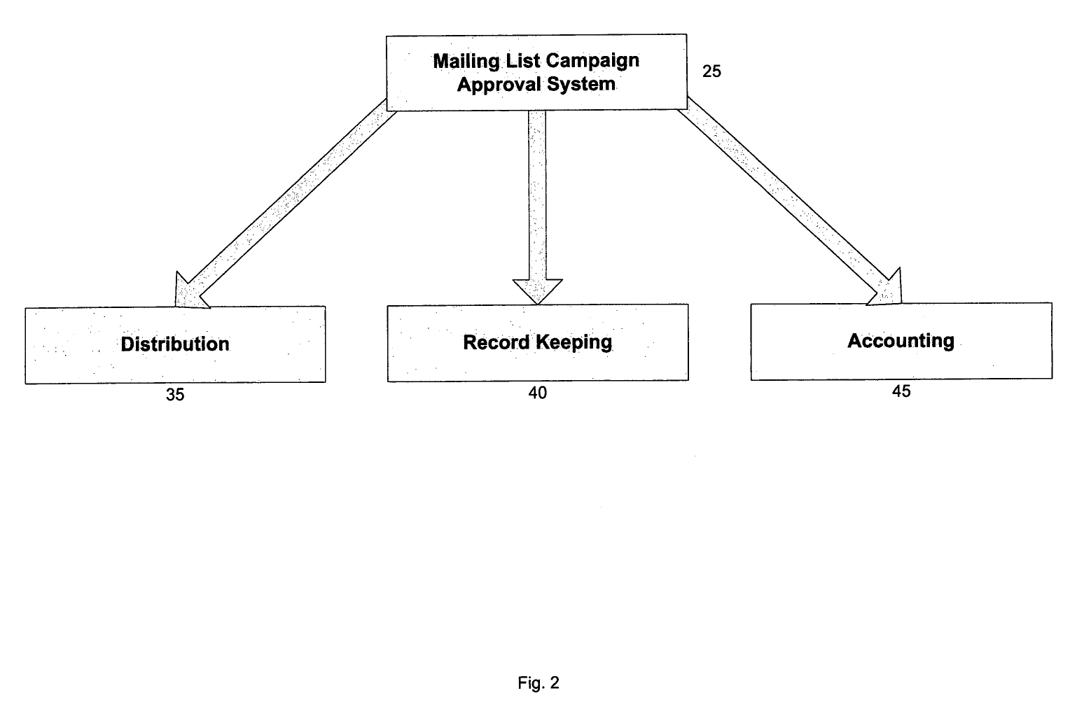

Referring now also to FIG. 2, when there is illustrated a functional block diagram of the mailing list campaign approval system 25. The system includes distribution functionalities 35 for the distribution of mailing lists, record keeping functionalities 40 for the mailing lists and accounting functionalities 45 relating to sales of the mailing lists. The distribution functionalities 35 enable automatic distribution of a mailing sample to mailing list owners associated with a particular mailing list that a mailing list purchaser may desire to purchase. The distribution functionalities 35 build a collection of list owners who are contributors to the database so that the mailing sample may be distributed to hundreds or thousands of list owners substantially simultaneously. The distribution functionalities 35 may also establish a unique link to mailing list owners that is certified and enables the mailing list owners to approve of the sample mailing. The record keeping functionalities 40 provide for a system that is paperless providing the mailing list owner with records of mailing samples and lists of approvals or disapprovals for various mailing samples. The accounting functionalities 45 provide accounting functions for the selling and maintaining of the mailing lists either the system database.

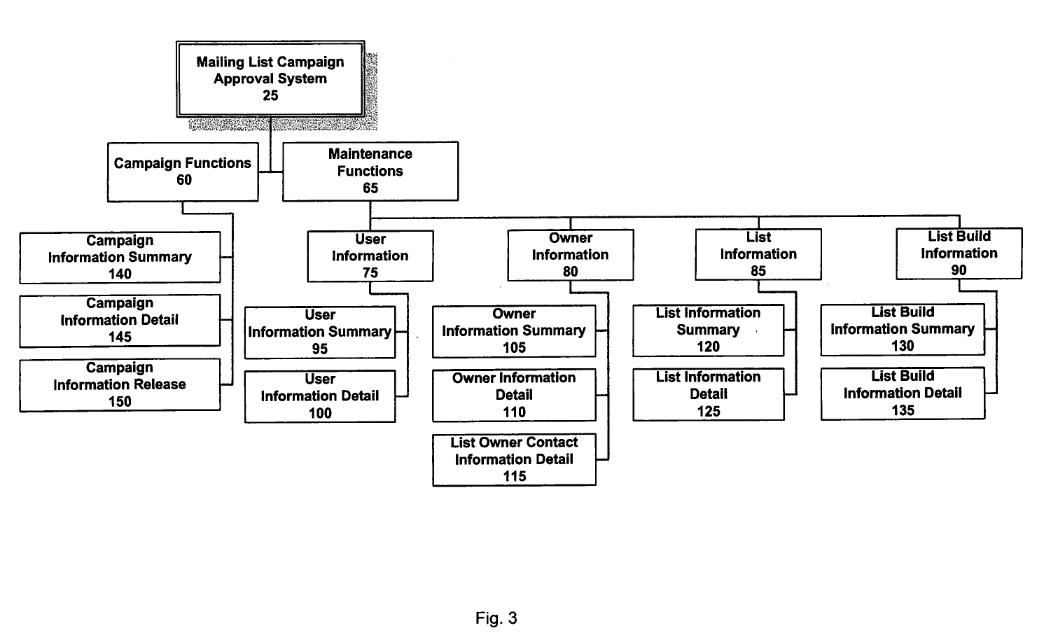

Referring now to FIG. 3, there is shown a functional block diagram of the mailing list campaign approval system and the various functionalities and operations provided by the system. The mailing list campaign approval system 25 includes two main functional areas including campaign functions 60 and maintenance functions 65. The campaign functions 60 include campaign information section 70 where individual mailing campaigns may be created, released and a user may check on approvals of various campaigns. Within the maintenance functions 65 there are included a user information section 75, an owner information section 80 and a list build information section 90.

The user information section 75 provides a listing of all administrator, campaign coordinator or user information along with their various security privileges and access levels. The user information section 75 provides control of access to the mailing campaign approval system 25. A user information summary section 95 provides for the addition, deletion and editing of various user records and for the establishment of security levels for user. The user information detail section 100 provides all information on a user including their name, user ID, user level, email address, phone number and fax number.

The owner information section 80 includes each list owner's information and where the owner is linked to a particular mailing list. From the owner information summary section 105, the records of list owners may be added, edited, deleted or printed. The summary section 105 provides a quick reference for the ID (owner ID), list owner's company name and state where the list owner is located. Detailed information on the owner may be accessed through the owner information detail section 110. The owner information detail section 110 enables list owner detail records to be created/edited. Each list owner record may have attached to it the name of the list owned by the list owner. The personal contacts for each list owner responsible for campaign approvals are also linked to the list owner record. Information which may be included within the owner information detail section 110 includes the company ID, company name, address for the company and other contact information. Whether or not the listed contact is active is also indicated. However, several contacts may be stored for a particular list owner, and the active contact may be changed or updated at any time. The list owner contact information detail section 115 provides detailed information on the individual who is responsible for approval of a list owner's list at the list owner company. Each list owner is linked to a corresponding list record or records. List owner detail records are created/edited through the owner information detail section 110. Information which may be edited includes the company ID, the company name, email address, phone number, fax number and the ability to activate or deactivate a particular contact.

The list information section 85 includes data relating to the name of a particular mailing list, an ID for the mailing list and a service bureau ID. The service bureau ID is the company that fulfills the list order. The list information section 85 includes a list information summary section 120 that provides the ability to add, edit, delete or print lists to be approved. The lists are quickly identified by the list name, list ID and service bureau ID. The list information detail section 125 provides a detailed listing of information associated with a particular mailing list and provides for the ability to create or edit the list. The information included within the list information detail section 125 include 5 the list name, the list ID, the owner, and the service bureau ID. Once all approvals have been received and the time limit for approvals has passed, an email is automatically generated to the system administrator for all approved list IDs along with their corresponding service bureau IDs. The resultant list IDs can then be transmitted to the list order fulfillment system to identify the list or lists to be selected for a particular mailer.

The list builds information section 90 provides a listing of the particular mailing lists to be approved. This enables the creation of subsets or groups of lists that may be included for approval by the list owner or a particular database build or particular mailer or particular mailing. List build records are added, edited deleted or printed from the section. The list build information summary section 130 includes the list build name, description of the build, the date the build was created and the status that shows which build is currently active. The build information detail section 135 enables the user to create a group of the list properties that can be associated with one particular build. Successive list builds of the database can contain the same lists as a previous build, or totally different lists. It is required that a name be given to a build, along with a description. This allows the user to select which lists are to be included in a particular build. This section provides information on the build name, the build description, the build date created, the status of the build which may be active or inactive and indication of whether or not a particular list is included within the build. Also included are information on the owner of the build, the name of the list included with a build and list IDs for the list included in the build.

The campaign information section 70 enables the creation, release and checking of approvals for individual mailing campaigns. The campaign information summary section 140 provides the functionalities for the adding, editing, deleting, releasing and printing of campaign approval records. The campaign information summary section 140 provides information on the internal PO number, campaign text name, mailer, release data and expiration date. Once ready for approval, campaigns may be released from this section and an associated campaign report printed out. Approvals of campaigns may also be monitored through this section. A lapse time for campaigns may be established by a user in this section. After a campaign has elapsed, no further changes can be made to the approval process. Campaign reports may be finalized after a campaign has elapsed. The campaign information detail section 145 enables the entry of pertinent details for sample approval for a mailer. The detail section 145 includes such information as the purchase order number, campaign name, description of the campaign, email subject, email body, the mailer, the broker, the build date created, the date released and the date for expiration of the campaign. Additionally, an image of the sample mailing piece may be created and uploaded enabling a user to view the mailer image. The campaign information release section 150 provides for the release of campaigns to a list owner for approval. The section 150 provides information that was brought forward from the campaign information detail section. But information within this section may not be altered. Information relating to the expiration of the campaign or the date released of the campaign, however, may be entered in this section.

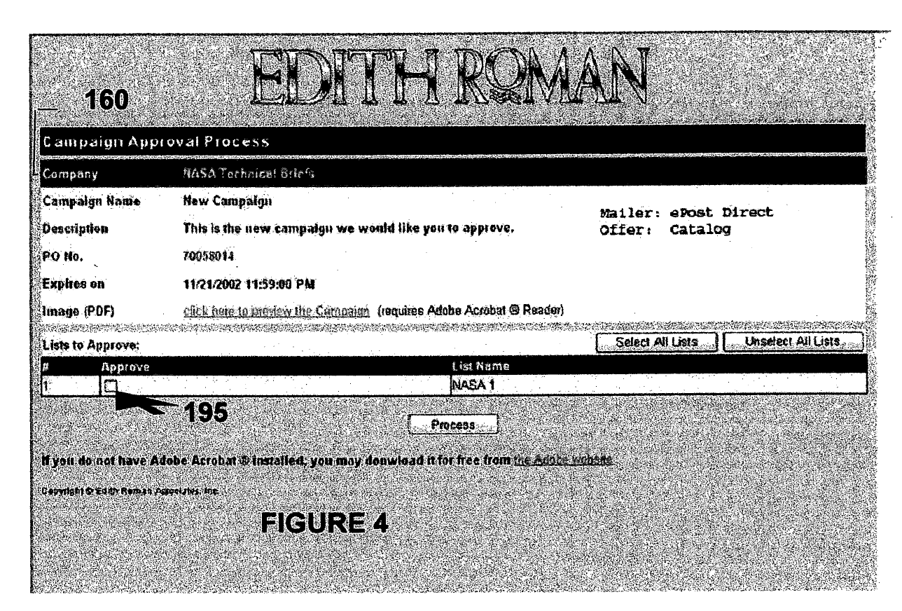

All list owners who own lists that are included in a campaign are sent an email with a link to the campaign approval process section 160. When the list owner clicks on the link in the email, an approval screen (FIG. 4) is displayed in the list owner's browser. This screen is where the list owner can approve or disapprove the use of their list for the mailer and offer identified. The approval screen can provide a graphic of the mailer sample piece. The image can be viewed and/or saved to the list owner's hard drive for further reference or archiving. Additionally, the approval screen displays the lists that the mailer wishes to use from the list owner for which approval is required. To approve, the approve box 195 must be checked; to disapprove, the list owner can either not respond to the request for approval, or respond with the approve box unchecked.

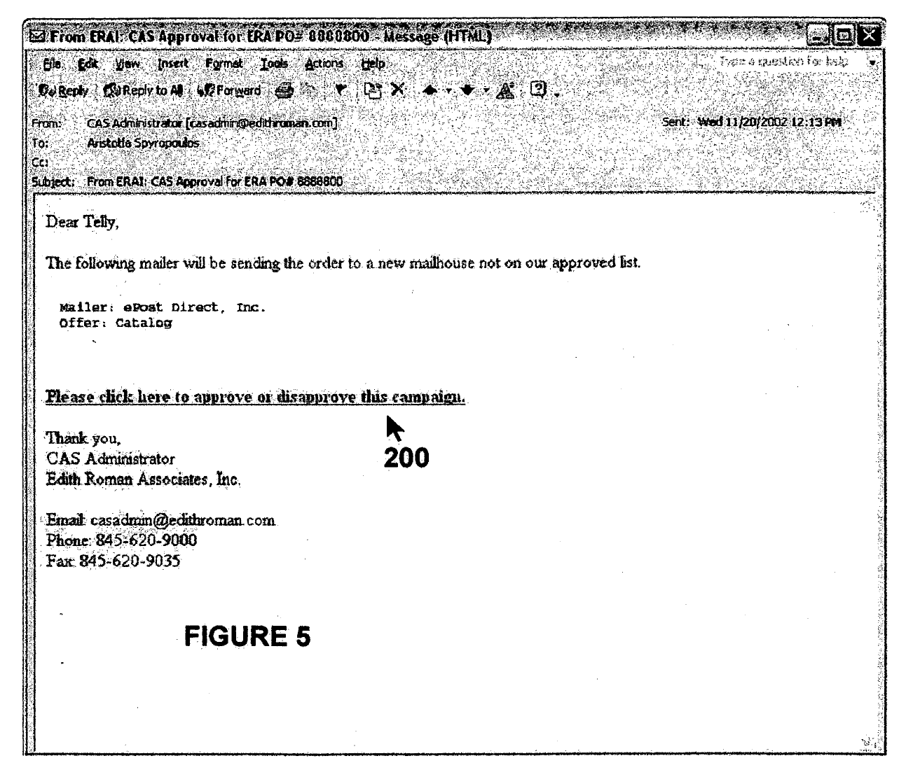

Referring now to FIG. 5, there is illustrated an example of an email that is sent to a list owner from the mailing list campaign approval system when there is a new campaign approval pending. The email contains an internal purchase order number assigned to the campaign, the mailer's name and an offer. A link 200 to the campaign approval system (publicly available link) where a sample of the proposed mailing piece can be viewed and an approval or disapproval may be made by the list owner.

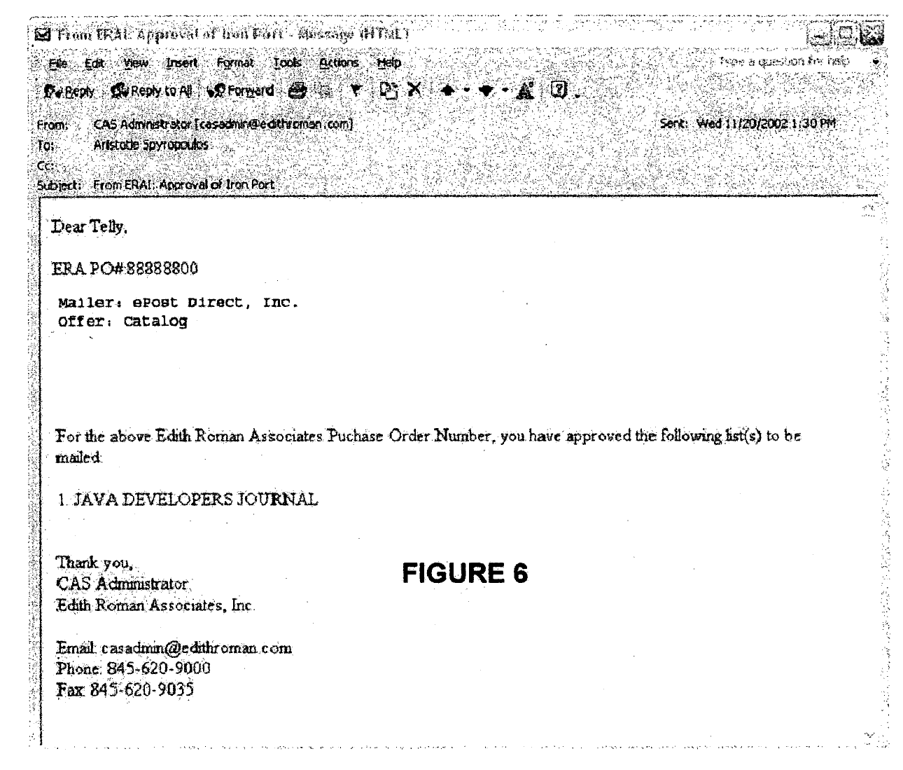

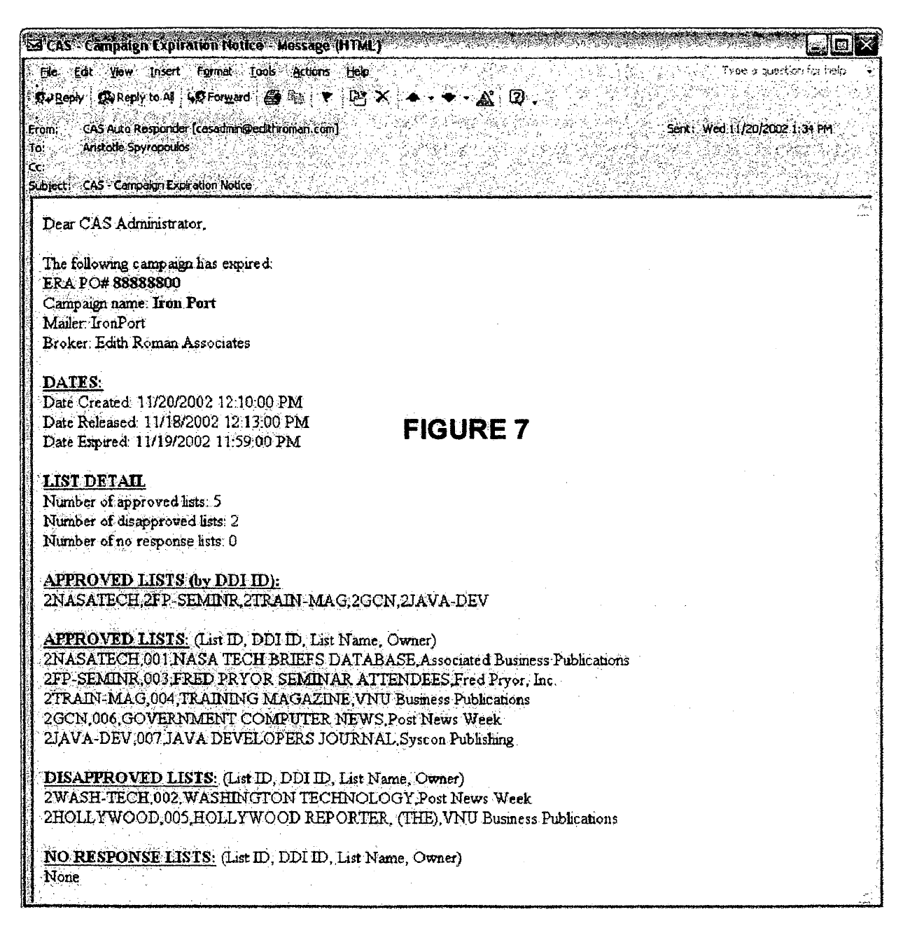

Referring now to FIG. 6, there is illustrated an exemplary list owner confirmation email. This is an example of an email that would be received by a list owner as confirmation that they have approved/disapproved the campaign and its associated lists. This is emailed to the list owner for their records, so that the owner has an easy, systematic method of keeping track of approvals and disapprovals. FIG. 7, illustrates an email that a campaign administrator receives after a campaign has expired. The campaign expiration notice reports on the approvals and disapprovals and no responses that the mailing list campaign approval system server logged during the campaign.

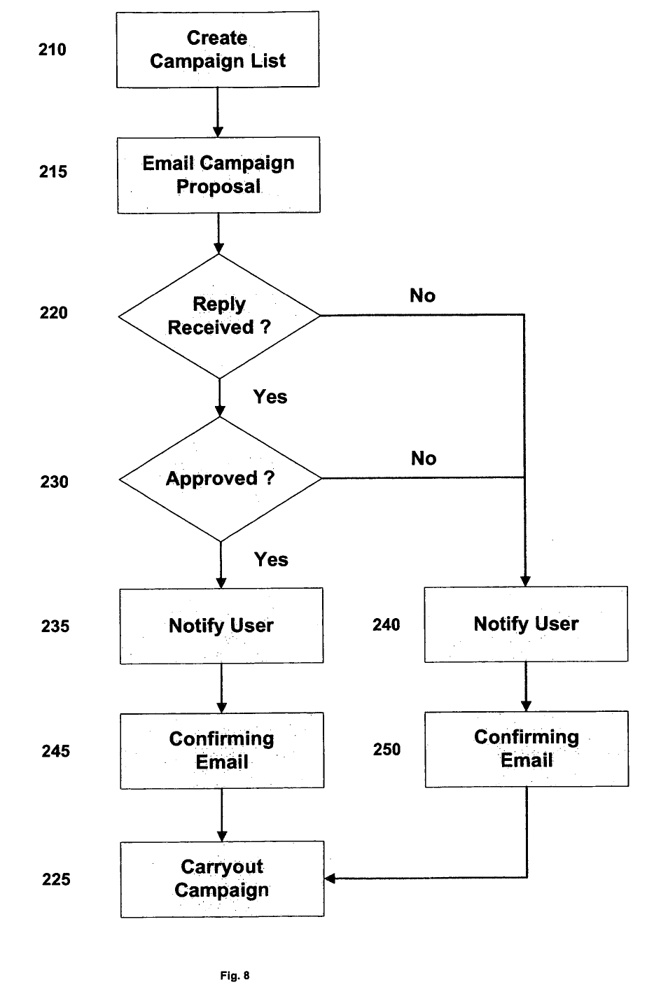

Referring now to FIG. 8, there is illustrated a flow diagram describing the manner in which a mailing list campaign may be approved according to the system of the present invention. A user creates a mailing campaign list at step 210. An email is sent of the campaign proposal to the list owner or owners at step 215. Inquiry step 220 determines whether a reply is received from the list owner in response to the email. If no response is received, the campaign is carried out according to the list owner at step 225. In this case, the list is not used and no campaign is performed. If a reply is received, inquiry step 230 determines whether the proposed mailing was approved or disapproved, and this is noted to the user at either step 235 or step 240 by the campaign approval system. A confirming email is transmitted to the list owner at either step 245 or step 250 and the campaign is then carried out in accordance with the instructions from the owner.

The previous description is of a preferred embodiment for implementing the invention, and the scope of the invention should not necessarily be limited by this description. The scope of the present invention is instead defined by the following claims.

What is claimed is:

1. A method for obtaining approval of a mailing list campaign, comprising the steps of:
forwarding a proposed mailing list campaign sample to a list owner via a computer network;
determining if the list owner replies to the proposed mailing list campaign sample; and
implementing the mailing list campaign in accordance with the step of determining.

2. The method of claim 1, wherein the step of forwarding further comprises the step of forwarding the proposed mailing list campaign sample to the list owner via an Internet.

3. The method of claim 1, wherein the step of determining further comprises the steps of:
receiving a reply to the forwarded proposed mailing list campaign sample via the network;
determining if the list owner approved the proposed mailing list campaign.

4. The method of claim 3, wherein the step of implementing further comprises the steps of:
if the list owner approved the mailing list campaign, beginning the approved mailing list campaign;
if the list owner does not approve the mailing list campaign, canceling the mailing list campaign.

5. The method of claim 3, further including the step of forwarding a confirmation message to the list owner responsive to the reply.

6. The method of claim 1, wherein the step of implementing further comprises the step of if the list owner does not reply to the proposed mailing list campaign, canceling the mailing list campaign.

7. A method for obtaining approval of a mailing list campaign, comprising the steps of:
forwarding a first email to a list owner via an Internet including a proposed mailing list campaign sample;
receiving a second email from the list owner via the Internet indicating approval or disapproval of the proposed mailing list campaign sample;
determining if the list owner approved or disapproved the mailing list campaign sample responsive to the second email; and
implementing the mailing list campaign according to the determination.

8. The method of claim 7, wherein the step of implementing further comprises the steps of:
if the list owner approved the mailing list campaign, beginning the approved mailing list campaign;
if the list owner does not approve the mailing list campaign, canceling the mailing list campaign.

9. The method of claim 7, further including the step of forwarding a confirmation message to the list owner responsive to the reply.

10. The method of claim 7, wherein the step of implementing further comprises the step of if the list owner does not reply to the proposed mailing list campaign canceling the mailing list campaign.

11. An apparatus for obtaining approval of a mailing list campaign, comprising:
a server providing interconnection with a network;
a mailing campaign approval system associated with the server, said mailing campaign approval system configured to:
forward a proposed mailing list campaign sample to a list owner via a computer network;
determining if the list owner replies to the proposed mailing list campaign sample; and
implementing the mailing list campaign in accordance with the step of determining.

12. The apparatus of claim 11, wherein the mailing list campaign approval system is further configured to forward the proposed mailing list campaign to the list owner via an Internet.

13. The method of claim 11, wherein the wherein the mailing list campaign approval system is further configured to:
receive a reply to the forwarded proposed mailing list campaign sample via the network;
determine if the list owner approved the proposed mailing list campaign.

14. The apparatus of claim 13, wherein the mailing list campaign approval system is further configured to forward a confirmation message to the list owner responsive to the reply.

15. The apparatus of claim 11, wherein the mailing list campaign approval system is further configured to cancel the mailing list campaign if the list owner does not reply to the proposed mailing list campaign.

16. The apparatus of claim 11, wherein the mailing list campaign approval system is further configured to:
if the list owner approved the mailing list campaign, begin the approved mailing list campaign;
if the list owner does not approve the mailing list campaign, cancel the mailing list campaign.

17. An apparatus for obtaining approval of a mailing list campaign, comprising:
a server providing interconnection with a network;
a mailing campaign approval system associated with the server, said mailing campaign approval system configured to:
forward a first email to a list owner via an Internet including a proposed mailing list campaign sample;
receive a second email from the list owner via the Internet indicating approval or disapproval of the proposed mailing list campaign sample;
determine if the list owner approved or disapproved the mailing list campaign sample responsive to the second email; and
implement the mailing list campaign according to the determination.

18. The apparatus of claim 17, wherein the mailing list campaign approval system is further configured to forward a confirmation message to the list owner responsive to the second email.

19. The apparatus of claim 17, wherein the mailing list campaign approval system is further configured to cancel the mailing list campaign if the list owner does not reply to the proposed mailing list campaign.

20. The apparatus of claim 17, wherein the mailing list campaign approval system is further configured to:
if the list owner approved the mailing list campaign, beginning the approved mailing list campaign;
if the list owner does not approve the mailing list campaign, canceling the mailing list campaign.
